(19) United States
(12) Patent Application Publication
(10) Pub. No.: US 2016/0192692 A1
(43) Pub. Date: Jul. 7, 2016

(54) FROTH BEVERAGE COMPOSITION AND PREPARATION METHOD THEREFOR

(71) Applicant: Samsung Fine Chemicals Co., Ltd., Ulsan (KR)

(72) Inventors: Hyun Woo LEE, Incheon (KR); Eun Jung LEE, Seoul (KR)

(21) Appl. No.: 14/442,371

(22) PCT Filed: Jul. 22, 2013
(86) PCT No.: PCT/KR2013/006520

§ 371 Date: May 12, 2015

(30) Foreign Application Priority Data
Nov. 13, 2012 (KR) 10-2012-0128261

(51) Int. Cl. A23L 2/40; A23C 9/156; A23C 9/154; A23L 2/56; A23L 2/52

(52) U.S. Cl. CPC A23L 2/40; A23L 2/56; A23L 2/52; A23C 9/154; A23C 9/156; A23V 2002/00

(57) ABSTRACT

A froth beverage composition and a preparation method therefor are disclosed. The disclosed froth beverage composition contains a flavoring agent containing a milk element and/or an excipient, and a cellulose ether-based compound, wherein the solid content of the cellulose ether-based compound is about 1 part to about 5 parts by weight with respect to 100 parts by weight of the solid content of the flavoring agent.

### TECHNICAL FIELD

The inventive concept relates to a froth beverage composition and a process for preparing the same, wherein a content of an animal derived component, such as a milk element, is reduced while maintaining a flavor of a conventional froth beverage, wherein the beverage have the same level of froth and the flavor as a conventional froth beverage while reducing a content of milk or a content of fat in milk, which is a potential cause of bovine spongiform encephalopathy and allergies and is also a main source of saturated fatty acid and cholesterols.

### BACKGROUND ART

Milk is highly nutritious food as it richly contains protein, fat, carbohydrate, calcium, and vitamins. Taste and nutrients of milk are well balanced, and thus milk itself is regarded as a complete food which is widely used as a raw material of various beverages, including coffee, fermented milk, ice cream, butter, and cheese. However, about 30% or more of a solid milk is a fat component, a content of a saturated fatty acid is as high as 70% of the fat component, and a content of cholesterol is about 30 mg/100 ml of milk, where such contents are relatively high in milk than other food in general.

Domestic coffee market and milk or dairy market has a rapid growth rate, and most of coffee beverage in the markets uses a predetermined amount of milk. This is because whey protein and milk fat in milk assist formation of froth, and the froth characteristics and milk fat ingredient make various beverages, including a coffee beverage, creamy. In coffee powder mix products, milk fat is replaced by vegetable oil, but due to characteristics of a powder product, coconut oil, palm oil, palm kernel oil, and hardened oil having a high content of saturated fat are used, and this is undesirable in terms of calories and health issues.

Recently many studies have been actively performed to solve the problems. For example, Korean Patent Publication No. 2011-0067329 discloses a coffee creamer including DATEM, mono- and di-glycerides, and sodium steatoyl lactylate instead of casein or sodium casein, which is included in a conventional coffee creamer at a content of about 3 wt % to about 6 wt % as an emulsifying additive, in regard of an issue of a synthetic additive in a coffee creamer. However, since this simply replaces an additive of the issue with another additive, the replacement is not preferable in terms of recent consumer trends to simplify food materials.

Also, Korean Patent Publication No. 2009-0027968 discloses a method of replacing fat of coffee creamer with a protein-based or carbohydrate-based material, and the disclosure was directed to reduce calories of the beverage while maintaining quality of the same level with a conventional beverage by using an alternative agent such as milk protein and dietary fibers. However, this is also not preferable in terms of increasing consumer expenses due to rise in costs and simplifying materials as described above.

Also, U.S. Pat. No. 6,048,567 discloses a foamable instant coffee product, but a specific gravity of creamer richly generating foam is relatively low and thus may not be homogenously mixed with a coffee powder with a high specific gravity. Therefore, in order to solve this, an additive, such as a carbonate or a hydrogen carbonate that may generate carbon dioxide at high temperature or under an acidic condition, and an acid (for adjusting pH) may be added to a creamer with a high specific gravity, although not richly generating foam. Also, a protein component may be supplemented to increase stability of the foam, but the disclosure does not include reduction in calories and fat in the creamer. Moreover, with respect to the research related to bubble stability in an emulsion of milk protein which generates the bubble by adding air to the emulsion, B. M. C. Pelan et al. (Journal of Dairy Chemistry, V80, pp 2631-2638) used a surfactant such as tween 60 (in which saturated fatty acid is bound to polyethylene sorbitan), but this is not suitable in terms of reducing calories and reducing contents of fat and saturated fatty acid.

### DETAILED DESCRIPTION OF THE INVENTIVE CONCEPT

### Technical Problem

The inventive concept provides a froth beverage composition having a reduced amount of an animal-derived component including a milk element while maintaining a flavor thereof.

The inventive concept provides a process for preparing the froth beverage composition.

### Technical Solution

According to an aspect of the inventive concept, there is provided a froth beverage composition including a flavoring agent including at least one of a milk element and an excipient; and a cellulose ether-based compound, wherein a solid content of the cellulose ether-based compound is in a range of about 1 part to about 5 parts by weight based on 100 parts by weight of a solid content of the flavoring agent.

The froth beverage may further include a vegetable main ingredient; and a congener, wherein solid contents of the flavoring agent and the congener are in a range of about 100 parts to about 900 parts and a range of about 0.2 parts to about 13 parts by weight, respectively, based on 100 parts by weight of the vegetable main ingredient.

The froth beverage composition may further include water, wherein a content of the water in the froth beverage composition is in a range of about 700 parts to about 14,000 parts by weight based on 100 parts by weight of the vegetable main ingredient.

The vegetable main ingredient may include at least one selected from the group consisting of coffee, cocoa, green tea, sweet potato, red tea, blueberry, and sweet pumpkin.

The congener may include at least one selected from the group consisting of coffee flavor, milk flavor, cream flavor, vanilla flavor, butter flavor, coconut flavor, chocolate flavor, oleaginous seed flavor, green tea flavor, sweet potato flavor, red tea flavor, blueberry flavor, and sweet pumpkin flavor.

The milk element may include at least one selected from the group consisting of raw milk, whole milk, low-fat milk, non-fat milk, functional milk, recombined milk, whole milk powder, skimmed milk powder, and whey powder.

The excipient may include at least one selected from the group consisting of maltodextrin, polydextrose, inulin, indigestible carbohydrates, whey protein, whey powder, casein, sodium caseinate, milk protein, whey protein isolate, water-soluble dietary fiber, and insoluble dietary fiber.

The cellulose ether-based compound may include at least one selected from the group consisting of hydroxypropylmethyl cellulose, methyl cellulose, and hydroxypropyl cellulose.

According to another aspect of the inventive concept, there is provided a process for preparing a froth beverage, the process including heating and stirring a mixture including at least one of a milk element and an excipient, a cellulose ether-based compound, and water to form froth.

The heating of the mixture may be performed at a temperature in a range of about 25° C. to about 75° C.

The mixture may further include at least one of a vegetable main ingredient and a congener.

### Advantageous Effects

According to one or more of exemplary embodiments, a froth beverage composition and a process for preparing a froth beverage may provide rich froth by using a cellulose ether-based compound while maintaining smoothness of a conventional coffee beverage product by imparting a milk-like flavor. The froth beverage composition has forth and flavor at the same level of those prepared by using milk, and a fat content and calories of the froth beverage composition are lower than those prepared by using milk.

### BEST MODE

Hereinafter, a froth beverage composition according to an embodiment and a process for preparing the froth beverage will be described.

The froth beverage composition may be a powder creamer type, a liquid creamer type, a premix type, or a liquid beverage type. Hereinafter, the froth beverage composition of each of the types will be described.

(Type 1: Froth Beverage Composition of Powder Creamer Type)

A froth beverage composition of a powder creamer type includes a flavoring agent powder including at least one of a milk powder (i.e., a milk element of a powder phase) and an excipient powder; and a cellulose ether-based compound powder, wherein a content of the cellulose ether-based compound powder may be in a range of about 1 part to about 5 parts by weight based on 100 parts by weight of the flavoring agent powder. When the content of the cellulose ether-based compound powder is less than 1 part by weight based on 100 parts by weight of the flavoring agent powder, formation of froth may not be sufficient, and stability of the froth thus formed may decrease. Also, when the content of the cellulose ether-based compound powder is greater than 5 parts by weight based on 100 parts by weight of the flavoring agent powder, a viscosity of the froth beverage increases and thus mouth-feel of the froth beverage may be deteriorated.

The milk powder is peculiar to impart creamy and smooth characteristics of milk to the froth beverage, and the froth may be formed by using a foamer.

The milk powder may include whole milk powder, skimmed milk powder, whey powder, or a mixture of two or more selected therefrom.

However, the froth milk composition according to an embodiment includes the cellulose ether-based compound powder, and thus a sufficient amount of froth may be formed therein and uniform froth may be maintained for a long period of time even when a milk powder with a low froth forming capability is used therein.

The excipient may be used to supplement or alternate the milk powder to provide flavor to the froth beverage.

The excipient may include, but not limited to, at least one selected from the group consisting of maltodextrin, polydextrose, inulin, indigestible carbohydrates, whey protein, whey powder, casein, sodium caseinate, milk protein, whey protein isolate, water-soluble dietary fiber, and insoluble dietary fiber. Examples of the dietary fiber may include chicory dietary fiber, inulin, oat dietary fiber, wheat dietary fiber, soybean dietary fiber, psyllium husk, wheat dietary fiber, sugar cane fiber, gums, and fructo-oligosaccharides.

Chicory is a dietary fiber dietary fiber, inulin, oat fiber, wheat fiber, soybean fiber, psyllium husk, wheat dietary fiber, sugar cane dietary fiber, gums, and fructo-oligosaccharides.

The cellulose ether-based compound powder is used to form the foam of the froth beverage so that a viscosity of the beverage does not decrease but increase even when a temperature of the beverage increases, and thus the foam may be maintained stably in a hot beverage for a long period of time. Accordingly, creamy mouth-feel may be easily given to the froth beverage, and such mouth-feel may be maintained for a long period of time.

The cellulose ether-based compound powder may include at least one selected from hydroxypropylmethyl cellulose, methyl cellulose, and hydroxypropyl cellulose. The hydroxypropylmethyl cellulose may include about 19 wt % to about 30 wt % of methoxy group and about 4 wt % to about 20 wt % of hydroxypropyl group that are substituted in the main chain of cellulose. The methyl cellulose may include about 19 wt % to about 30 wt % of methoxy group that is substituted in the main chain of cellulose. The hydroxypropyl cellulose may include about 4 wt % to about 20 wt % of hydroxypropyl group that is substituted in the main chain of cellulose. Also, the cellulose ether-based compound powder may have a viscosity in a range of about 50 cps to about 10,000 cps (centipoise) with respect to an aqueous solution having a concentration of 2 wt % at room temperature (e.g, 25° C.).

The froth is formed at a desired level by adding the cellulose ether-based compound powder to water or an aqueous composition and stirring at a rate of about 100 rpm to about 3,000 rpm.

Also, the cellulose ether-based compound powder may be gelated at a temperature of about 65° C. or higher after being solved to water or an aqueous composition, and thus when a temperature of the solved cellulose ether-based compound powder increases and passes a gelation point while the froth is sufficiently formed, a type of a gel matrix is formed, and then it may be stabilized.

(Type 2: Froth Beverage Composition of Liquid Creamer Type)

A froth beverage composition of a liquid creamer type includes a flavoring agent, a cellulose ether-based compound, and water.

A relative content of the flavoring agent and the cellulose ether-based compound in the froth beverage composition of a liquid creamer type may be the same as a relative content of the flavoring agent powder and the cellulose ether-based compound in the froth beverage composition of a powder creamer type.

A content of water in the froth beverage composition of a liquid creamer type may be in a range of about 35 wt % to about 95 wt %.

The flavoring agent and the cellulose ether-based compound of the froth beverage composition of a liquid creamer type may be derived from the flavoring agent powder and the cellulose ether-based compound powder used in the preparation of the froth beverage composition of a powder creamer type, respectively. In this case, the flavoring agent powder and the cellulose ether-based compound powder may be mixed with water to be used in the preparation of the froth beverage composition of a liquid creamer type.

In another embodiment, the flavoring agent may include a milk element derived from liquid milk. Here, the liquid milk and the cellulose ether-based compound powder may be mixed with water to prepare the froth beverage composition of a liquid creamer type.

The liquid milk may include raw milk, whole milk, low-fat milk, non-fat milk, functional milk, recombined milk, or a mixture of two or more selected therefrom.

The raw milk denotes unprocessed milk taken from a cow.

The whole milk denotes milk prepared from the raw milk without removing fat, but the milk is commercially sterilized at a temperature of about 120° C. to about 140° C. for several seconds or sterilized at a low temperature (e.g., at 63° C. for 30 minutes or at 72° C. for 15 seconds).

The low-fat milk denotes milk prepared by removing a part of a milk fat component from the raw milk, and, for example, a content of the milk fat component in the low-fat milk may be 1/2 or 1/100 of its original content in the raw milk.

The non-fat milk denotes milk prepared by removing all of a milk fat component from the raw milk.

The functional milk denotes milk having enhanced functionality prepared by adding various functional components, for example, calcium or docosa hexaenoic acid (DHA), to whole milk.

The recombined milk denotes milk prepared by dissolving at least one selected from the group consisting of whole milk powder, skimmed milk powder, and whey powder, in water. Examples of the recombined milk include recombined whole milk and recombined low-fat milk. The recombined milk may undergo additional sterilization and pasteurization process. In the preparation of the recombined milk, contents of the whole milk powder and the skimmed milk powder may be appropriately selected. For example, in the preparation of the recombined whole milk, 12 wt % of the whole milk powder may be used (i.e., 12 g of the whole milk powder is dissolved in 88 g of water). For example, in the preparation of the recombined low-fat milk, 10 wt % of the skimmed milk powder may be used (i.e., 10 g of the skimmed milk powder is dissolved in 90 g of water).

Unlike other types of liquid milk, the recombined milk uses milk powder of a powder state during the storage and distribution stages, and thus the recombined milk has many advantages in terms of its expiration date and ease of handling. However, the recombined milk is generally treated at an extremely high temperature compared to liquid milk products, and thus a degree of denaturization of protein is high, which results in significantly low capability of froth formation. For example, when the whole milk powder is used to prepare the recombined milk, formation of uniform froth from the recombined milk may be difficult. Meanwhile, the skimmed milk powder is used to prepare the recombined milk, froth with high thickness may be formed, but the froth of the recombined milk may be inferior to that formed by using whole milk in terms of the uniformity and amount of the froth.

(Type 3: Froth Beverage Composition of Premix Type)

A froth beverage composition of a premix type further includes a vegetable main ingredient powder and a congener powder in addition to the flavoring agent powder and the cellulose ether-based compound powder, which are the same as those used in the preparation of the froth beverage composition of a powder creamer type, respectively.

In the froth beverage composition of a premix type, a relative content of the flavoring agent powder and the cellulose ether-based compound may be the same as a relative content of the flavoring agent powder and the cellulose ether-based compound in the froth beverage composition of a powder creamer type.

The vegetable main ingredient may include at least one selected from the group consisting of coffee, cocoa, green tea, sweet potato, red tea, blueberry, and sweet pumpkin. The coffee may be prepared by roasting and pulverizing various types of coffee beans in the form of a coffee powder.

The vegetable main ingredient may be prepared in the form of a powder, and the vegetable main ingredient powder determines main taste of a beverage.

A content of the flavoring agent powder may be in a range of about 100 parts to about 900 parts by weight based on 100 parts by weight of the vegetable main ingredient powder. When the content of the flavoring agent powder is within this range, a froth beverage having a desired flavor may be obtained.

The flavoring agent powder may include milk powder and an excipient powder as described above.

Contents of the milk powder and the excipient powder may be in a range of about 0 part to about 500 parts by weight and in a range of about 40 parts to about 500 parts by weight, respectively, based on 100 parts by weight of the vegetable main ingredient powder. When the contents of the milk powder and the excipient powder are within these ranges, respectively, a froth beverage, having low calories and low contents of fat and cholesterol while sufficiently providing creamy flavor and smooth mouth-feel to a consumer, may be obtained.

The congener powder further increases flavor of the froth beverage. The congener powder may include, but not limited to, at least one selected from the group consisting of coffee flavor, milk flavor, cream flavor, vanilla flavor, butter flavor, coconut flavor, chocolate flavor, oleaginous seed flavor, green tea flavor, sweet potato flavor, red tea flavor, blueberry flavor, and sweet pumpkin flavor.

A content of the congener powder may be in a range of about 0.2 part to about 13 parts by weight based on 100 parts by weight of the vegetable main ingredient powder. When the content of the congener powder is within this range, a froth beverage having both excellent flavor and mouth-feel may be obtained.

(Type 4: Froth Beverage Composition of Liquid Beverage Type)

A froth beverage composition of a liquid beverage type may include a flavoring agent, a cellulose ether-based compound, a vegetable main ingredient, a congener, and water.

The flavoring agent may be derived from the same flavoring agent powder as that used in the preparation of the froth beverage composition of a powder creamer type as described above. However, embodiments are not limited thereto, and when the flavoring agent includes a milk element, the milk element may be derived from the same liquid milk as that used in the preparation of the froth beverage composition of a liquid creamer type described above.

The cellulose ether-based compound may be the same cellulose ether-based compound as that used in the preparation of the froth beverage composition of a powder creamer type described above.

In the froth beverage composition of a liquid beverage type, a relative content of the flavoring agent and the cellulose ether-based compound may be the same as a relative content of the flavoring agent powder and the cellulose ether-based compound powder in the froth beverage composition of a powder creamer type.

The vegetable main ingredient and the congener may be derived from the same vegetable main ingredient powder and the congener powder as those used in the preparation of the froth beverage composition of a premix type described above.

In the froth beverage composition of a liquid beverage type, a relative content of the flavoring agent, the vegetable main ingredient, and the congener may be the same as a relative content of the flavoring agent powder, the vegetable main ingredient, and the congener in the froth beverage composition of a premix type.

A content of the water may be in a range of about 700 parts to about 14,000 parts by weight based on 100 parts by weight of the vegetable main ingredient. The water may be purified water, or, in particular, primary purified water or secondary purified water.

When the vegetable main ingredient includes coffee, the coffee may be used in the preparation of a froth beverage as a coffee solution type prepared by extracting and diluting a coffee stock solution from a powdered type coffee that is obtained by roasting and pulverizing various types of coffee beans, or as a coffee solution type prepared by dissolving a commercially available coffee powder in water. A concentration of coffee in the coffee solution may be in a range of about 0.2 wt % to about 3 wt %.

When the vegetable main ingredient includes cocoa, the cocoa may be used in the preparation of a froth beverage as a cocoa solution type prepared by dissolving a cocoa powder in water, and a concentration of cocoa in the cocoa solution may be in a range of about 0.5 wt % to about 3 wt %.

The coffee solution and the cocoa solution as the vegetable main ingredient may be mixed and used together, and a ratio of the coffee solution and the cocoa solution may be in a range of about 1:9 to about 9:1 based on weights of the coffee solution and the cocoa solution.

When the vegetable main ingredient includes green tea, sweet potato, red tea, blueberry, and/or sweet pumpkin, raw materials of the green tea, sweet potato, red tea, blueberry, and/or sweet pumpkin may be processed to prepare a worked material in the form of a concentrated solution, a powder, or a paste, and the worked material may be dissolved or dispersed in water to be used in the preparation of a froth beverage. Furthermore, a flavoring agent and/or a congener may be added to the worked material to prepare a froth beverage composition of a mousse type. In the froth beverage composition of a mousse type, a concentration of the vegetable main ingredient may be in a range of about 0.5 wt % to about 5 wt %.

In the froth beverage composition of a liquid beverage type, a content of the vegetable main ingredient may be in a range of about 0.5 wt % to about 5 wt % based on the total weight of the froth beverage composition of a liquid beverage type. When the content of the vegetable main ingredient is within this range, a froth beverage including the froth beverage composition may have excellent flavor and mouth-feel.

In the froth beverage composition of a liquid beverage type, a solid content of the cellulose ether-based compound may be in a range of about 0.05 wt % to about 1.0 wt %, for example, about 0.1 wt % to about 0.15 wt %, or about 0.3 wt % to about 0.4 wt % based on the total weight of the froth beverage composition of a liquid beverage type. When the solid content of the cellulose ether-based compound is within this range, a froth beverage including the froth beverage composition may have foam having a sufficient thickness and high stability, and mouth-feel of the beverage may be maintained at high level as a viscosity of the beverage is not high.

In the froth beverage composition of a liquid beverage type, when the flavoring agent includes a milk element and an excipient, solid contents of the milk element and the excipient may be in a range of about 0 wt % to about 3.6 wt % and in a range of about 0.1 wt % to about 5 wt %, respectively, based on the total weight of the froth beverage composition of a liquid beverage type. When each of the solid contents of the milk element and the excipient is within the respective range, a froth beverage including the froth beverage composition may have low calories and low contents of fat and cholesterol while sufficiently providing creamy flavor and smooth mouth-feel to a consumer.

In the froth beverage composition of a liquid beverage type, a content of the congener may be in a range of about 0.01 wt % to about 1 wt % based on the total weight of the froth beverage composition of a liquid beverage type. When the content of the congener is within this range, a froth beverage including the froth beverage composition may have both excellent flavor and mouth-feel.

The froth beverage composition may be a coffee beverage composition, a cocoa beverage composition, a green tea beverage composition, a sweet potato beverage composition, a red tea beverage composition, a blueberry beverage composition, or a sweet pumpkin beverage composition.

The froth beverage may be a coffee beverage, a cocoa beverage, a green tea beverage, a sweet potato beverage, a red tea beverage, a blueberry beverage, or a sweet pumpkin beverage.

Hereinafter, a process for preparing a froth beverage according to an embodiment will be described in detail.

The process for preparing a froth beverage according to an embodiment includes heating and stirring a mixture including at least one of a milk element and an excipient; a cellulose ether-based compound; and water to form froth or foam. The heating of the mixture may be performed at a temperature in a range of about 25° C. to about 75° C.

In one embodiment, the process for preparing a froth beverage may include, first, pre-mixing the cellulose ether-based compound with an excipient and a congener to prepare a pre-mixture; forming froth milk by stirring a mixture solution prepared by mixing the pre-mixture and a premade milk element while heating the mixture solution; and mixing the froth milk with at least one of a coffee solution and a cocoa solution.

Types and contents of the cellulose ether-based compound, excipient, and congener are the same as those described above.

In the pre-mixing process, the cellulose ether-based compound, the excipient, and the congener may be mixed to one another in a powder state. Also, the three ingredients may be mixed together with water.

The formation of the froth milk may be performed until a sufficient amount of froth is formed, for example, for about 1 minute to about 5 minutes.

The froth milk may be mixed with coffee powder or solution and/or cocoa powder or solution to prepare a froth beverage.

When coffee solution and/or cocoa solution is mixed with the froth milk, the coffee solution and/or the cocoa solution at a high temperature (e.g., in a range of about 60° C. to about 95° C.) may be mixed with the froth milk.

In another embodiment, the process for preparing a froth beverage may include pre-mixing the vegetable main ingredient, the cellulose ether-based compound, the excipient, and the congener to prepare a pre-mixture; and heating and stirring a mixture solution prepared by mixing the pre-mixture and a premade milk element to form froth.

### MODE OF THE INVENTIVE CONCEPT

Hereinafter, embodiments will be described in detail by referring to examples, but embodiments are not limited thereto.

### EXAMPLES

### Experimental Example 1

In order to realize a coffee beverage having reduced calories and fat content while maintaining creamy and smooth characteristics peculiar to milk, the following experiment was performed.

(1) Confirmation of possibility of milk content reduction

Formation of milk froth was confirmed with a hot type by using a milk foamer (LM-300P, available from Top Electric Appliance Industry). The milk foamer are equipped with a heating device and a stirring device, and thus when a hot-type is selected, a cold storage or room temperature (25° C.) milk composition is heated while the composition is vigorously stirred at the same time, and the stirring stopped when a temperature of the composition reaches a final temperature (75° C.). A degree of froth formation in the case of the milk composition including liquid milk at a content of 100 wt %, 90 wt %, 80 wt %, 70 wt %, 60 wt %, 50 wt %, 40 wt %, 30 wt %, 20 wt %, or 10 wt % (where, the remaining content was purified water) with respect to whole milk (available from Maeil Dairies Co., Ltd., a solid content: 12 wt %) and low-fat milk (i.e., skim milk) (available from Seoul Dairy Co., a solid content: 10 wt % and a content of fat: 1 wt %) was shown in Table 1. In Table 1, the term “initial volume” denotes a volume of the milk composition at room temperature before the heating; the term “elapsed time” denotes a period of time elapsed after a temperature of the composition reached 75° C. (at which the elapsed time is 0 minute) by heating the milk composition at room temperature; and the term “volume change ratio according to elapsed time” denotes a volume change ratio at a certain elapsed time with respect to 200 ml of an initial volume.

TABLE 1

| | Content of | Volume change ratio according to | | | | | | Cream | |
|---|---|---|---|---|---|---|---|---|---|
| | liquid milk | elapsed time (%) | | | | | | flavor | Froth |
| | (wt %) | 0 min | 3 min | 6 min | 9 min | 12 min | 15 min | intensity | uniformity |
| Whole | 100 | 346 | 312 | 297 | 284 | 263 | 253 | 5.0 | Very |
| milk | | | | | | | | | uniform |
| | 90 | 351 | 303 | 289 | 263 | 253 | 233 | 5.0 | Very |
| | | | | | | | | | uniform |
| | 80 | 353 | 303 | 279 | 267 | 250 | 228 | 4.0 | Very |
| | | | | | | | | | uniform |
| | 70 | 349 | 317 | 292 | 266 | 248 | 232 | 3.5 | Uniform |
| | 60 | 355 | 326 | 312 | 286 | 260 | 234 | 3.0 | Uniform |
| | 50 | 155 | 138 | 131 | 127 | 129 | 130 | 2.5 | Non-uniform |
| | 40 | 132 | 124 | 128 | 129 | 128 | 128 | 2.0 | Non-uniform |
| | 20 | 111 | 108 | 106 | 108 | 108 | 108 | 1.5 | Non-uniform |
| | 10 | 111 | 108 | 108 | 104 | 104 | 105 | 1.0 | Non-uniform |
| Low-fat | 100 | 356 | 322 | 302 | 293 | 281 | 274 | 2.5 | Very |
| milk | | | | | | | | | uniform |
| | 90 | 325 | 286 | 260 | 251 | 239 | 228 | 2.3 | Very |
| | | | | | | | | | uniform |
| | 80 | 257 | 225 | 218 | 210 | 197 | 182 | 2.3 | Uniform |
| | 70 | 127 | 121 | 112 | 108 | 104 | 102 | 2.0 | Non-uniform |
| | 60 | 113 | 112 | 108 | 104 | 103 | 102 | 2.0 | Non-uniform |
| | 50 | 105 | 103 | 102 | 101 | 102 | 103 | 2.0 | Non-uniform |
| | 40 | 107 | 106 | 105 | 105 | 101 | 102 | 2.0 | Non-uniform |
| | 30 | 103 | 102 | 101 | 106 | 104 | 103 | 1.5 | Non-uniform |
| | 20 | 102 | 102 | 103 | 102 | 102 | 101 | 1.0 | Non-uniform |
| | 10 | 105 | 103 | 101 | 102 | 103 | 102 | 1.0 | Non-uniform |

<Evaluation Criteria>

(1) A cream flavor intensity was evaluated based on a 5-point scale. A point of a greater number denotes greater intensity of the cream flavor.

(2) Froth uniformity

In case froth was formed, whether the froth was decomposed or not during 15 minutes of elapsed time after the point of time when the froth was formed was observed with naked eyes, and the results were evaluated based on the criteria below.
Very uniform: no change in size of froth was observed
Uniform: size of froth was uniform in 80% or more of observed surface
Non-uniform: froth was not formed, or size of froth is significantly irregular.

Referring to Table 1, in the case of whole milk, when the froth of the milk composition was formed at a temperature of about 75° C., it may be confirmed that the results were positive when a content of the liquid milk was at least 60%, and the total volume of the milk composition including the froth increased to about 350% (about 700 ml) or greater of the initial volume of 200 ml. Also, the cream flavor intensity decreased rapidly according to a content of the liquid milk.

Also, referring to Table 1, in the case of low-fat milk (skim milk), it may be confirmed that a content of the liquid milk should be at least 80% in order to form the froth. This corresponds to the research results of B.M.C. Pelan et al. (Journal of Dairy Chemistry, V80, pp 2631-2638) disclosing that whey protein and milk fat are involved in formation of froth of milk. Also, in the case of low-fat milk, a content of fat is about 1 wt %, which is about 1/3 to about 1/4 of a content of fat in whole milk (having about 3.5 wt % to about 4.0 wt % of a content of fat), and thus a cream flavor intensity of the low-fat milk was significantly low.

### Experimental Example 2

Degrees of forming froth of recombined whole milk (a solid content: 12 wt %) and recombined low-fat milk (a solid content: 10 wt %) were measured in the same manner as in the cases of whole milk and low fat milk of Experimental Example 1, and the results are shown in Table 2. The recombined whole milk and the recombined low-fat milk were products of Seoul Milk.

TABLE 2

| | Content of | Volume change ratio according to | | | | | | Cream | |
|---|---|---|---|---|---|---|---|---|---|
| | liquid milk | elapsed time (%) | | | | | | flavor | Froth |
| | (wt %) | 0 min | 3 min | 6 min | 9 min | 12 min | 15 min | intensity | uniformity |
| Recombined | 100 | 177 | 158 | 157 | 150 | 153 | 153 | 4.5 | Non-uniform |
| whole | 75 | 130 | 127 | 121 | 118 | 119 | 119 | 3.0 | Non-uniform |
| milk | 50 | 121 | 114 | 112 | 112 | 112 | 112 | 2.0 | Non-uniform |
| | 25 | 105 | 105 | 105 | 105 | 105 | 105 | 1.5 | Non-uniform |
| Recombined | 100 | 314 | 279 | 258 | 250 | 229 | 219 | 2.5 | Non-uniform |
| low-fat | 75 | 346 | 324 | 244 | 229 | 216 | 216 | 2.5 | Non-uniform |
| milk | 50 | 188 | 172 | 160 | 159 | 167 | 167 | 2.0 | Non-uniform |
| | 25 | 183 | 169 | 164 | 163 | 169 | 169 | 1.5 | Non-uniform |

Referring to Tables 1 and 2, uniformity of the froth of recombined whole milk was significantly low, and an amount of the produced froth was also significantly low compared to that of whole milk. Also, an amount of the froth of recombined low-fat milk was similar to that of whole milk, but uniformity of the froth of recombined low-fat milk was significantly low. It is deemed as this is because of froth formation capability of the recombined milk that is significantly low compared to that of whole milk due to a high degree of denaturation of protein resulted from heat-treatment compared to that of whole milk.

### Experimental Example 3

Froth formation by using a coffee beverage composition, which includes liquid milk of 50 wt % {e.g., whole milk, low-fat milk, recombined whole milk (a solid content: 12 wt %) or recombined low-fat milk (a solid content: 10 wt %)}, which hardly forms froth, and hydroxypropylmethyl cellulose (HPMC) added to the liquid milk was conducted in the same manner as in Experimental Example 1 under the same conditions described in Tables 3 and 4, and the results are shown in Tables 3 and 4. Here, the final temperature and the initial volume were set as 75° C. and 200 ml, respectively. Also, HPMC used herein was AnyAddy® available from Samsung Fine Chemical.

TABLE 3

| | | Final | | | | | | | | |
|---|---|---|---|---|---|---|---|---|---|---|
| | Form of | concentration | Volume change ratio according to | | | | | | Cream | |
| | HPMC | of HPMC | elapsed time (%) | | | | | | flavor | Froth |
| | used | (wt %) | 0 min | 3 min | 6 min | 9 min | 12 min | 15 min | intensity | uniformity |
| Whole | Powder | 0.1 | 269 | 227 | 208 | 195 | 188 | 179 | 3.5 | Collapse |
| milk | | | | | | | | | | was |
| | | | | | | | | | | observed |
| | | 0.2 | 272 | 281 | 253 | 236 | 229 | 222 | 3.5 | Very |
| | | | | | | | | | | uniform |
| | | 0.3 | 316 | 279 | 259 | 245 | 237 | 229 | 3.5 | Very |
| | | | | | | | | | | uniform |
| | | 0.4 | 309 | 288 | 268 | 263 | 250 | 242 | 3.5 | Very |
| | | | | | | | | | | uniform |
| | | 0.5 | 301 | 273 | 264 | 262 | 250 | 242 | 3.5 | Very |
| | | | | | | | | | | uniform |
| | 2 wt % | 0.1 | 312 | 289 | 277 | 262 | 245 | 234 | 3.5 | Collapse |
| | Aqueous | | | | | | | | | was |
| | solution | | | | | | | | | observed |
| | | 0.2 | 321 | 303 | 292 | 520 | 286 | 271 | 3.5 | Very |
| | | | | | | | | | | uniform |
| | | 0.3 | 312 | 303 | 298 | 294 | 290 | 290 | 3.5 | Very |
| | | | | | | | | | | uniform |
| | | 0.4 | 298 | 290 | 279 | 257 | 256 | 238 | 3.5 | Very |
| | | | | | | | | | | uniform |
| | | 0.5 | 271 | 260 | 259 | 242 | 240 | 227 | 3.5 | Very |
| | | | | | | | | | | uniform |
| Low-fat | Powder | 0.1 | 330 | 280 | 243 | 223 | 215 | 208 | 3.0 | Collapse |
| milk | | | | | | | | | | was |
| | | | | | | | | | | observed |
| | | 0.2 | 311 | 289 | 269 | 268 | 245 | 220 | 3.0 | Very |
| | | | | | | | | | | uniform |
| | | 0.3 | 333 | 297 | 276 | 262 | 260 | 247 | 3.0 | Very |
| | | | | | | | | | | uniform |
| | | 0.4 | 324 | 299 | 284 | 266 | 255 | 242 | 3.0 | Very |
| | | | | | | | | | | uniform |
| | | 0.5 | 304 | 290 | 284 | 267 | 262 | 262 | 3.0 | Very |
| | | | | | | | | | | uniform |
| | 2 wt % | 0.1 | 330 | 299 | 278 | 262 | 255 | 245 | 3.0 | Collapse |
| | Aqueous | | | | | | | | | was |
| | solution | | | | | | | | | observed |
| | | 0.2 | 337 | 318 | 311 | 305 | 291 | 294 | 3.0 | Very |
| | | | | | | | | | | uniform |
| | | 0.3 | 294 | 268 | 264 | 259 | 252 | 250 | 3.0 | Very |
| | | | | | | | | | | uniform |
| | | 0.4 | 268 | 235 | 224 | 219 | 220 | 212 | 3.0 | Very |
| | | | | | | | | | | uniform |
| | | 0.5 | 263 | 249 | 215 | 219 | 220 | 215 | 3.0 | Very |
| | | | | | | | | | | uniform |

Referring to Table 3, when the cellulose ether-based compound (HPMC) was prepared in the form of a powder or a 2 wt % aqueous solution, added to whole milk or low-fat milk, heated and stirred to form froth, a sufficient amount of forth was formed at every concentration of HPMC, and thus cream flavor intensities increased. In this regard, it was confirmed that a froth beverage with improved mouth-feel may be prepared with a small amount of milk.

TABLE 4

| | | Final | | | | | | | | |
|---|---|---|---|---|---|---|---|---|---|---|
| | Form of | concentration | Volume change ratio according to | | | | | | Cream | |
| | HPMC | of HPMC | elapsed time (%) | | | | | | flavor | Froth |
| | used | (wt %) | 0 min | 3 min | 6 min | 9 min | 12 min | 15 min | intensity | uniformity |
| Recombined | Powder | 0.1 | 319 | 284 | 241 | 222 | 206 | 176 | 3.5 | Collapse |
| whole | | | | | | | | | | was |
| milk | | | | | | | | | | observed |
| | | 0.2 | 322 | 307 | 297 | 278 | 253 | 242 | 3.5 | Very |
| | | | | | | | | | | uniform |
| | | 0.3 | 306 | 285 | 264 | 253 | 247 | 242 | 3.5 | Very |
| | | | | | | | | | | uniform |
| | | 0.4 | 272 | 245 | 240 | 235 | 233 | 232 | 3.5 | Very |
| | | | | | | | | | | uniform |
| | | 0.5 | 267 | 245 | 242 | 242 | 238 | 237 | 3.5 | Very |
| | | | | | | | | | | uniform |
| | 2 wt % | 0.1 | 321 | 278 | 232 | 190 | 174 | 166 | 3.5 | Collapse |
| | Aqueous | | | | | | | | | was |
| | solution | | | | | | | | | observed |
| | | 0.2 | 310 | 296 | 280 | 260 | 228 | 216 | 3.5 | Very |
| | | | | | | | | | | uniform |
| | | 0.3 | 298 | 289 | 285 | 279 | 272 | 268 | 3.5 | Very |
| | | | | | | | | | | uniform |
| | | 0.4 | 284 | 262 | 262 | 255 | 251 | 253 | 3.5 | Very |
| | | | | | | | | | | uniform |
| | | 0.5 | 257 | 247 | 242 | 236 | 236 | 236 | 3.5 | Very |
| | | | | | | | | | | uniform |
| Recombined | Powder | 0.1 | 326 | 300 | 295 | 288 | 286 | 286 | 3.0 | Very |
| low-fat | | | | | | | | | | uniform |
| milk | | 0.2 | 324 | 311 | 303 | 297 | 291 | 284 | 3.0 | Very |
| | | | | | | | | | | uniform |
| | | 0.3 | 315 | 302 | 298 | 293 | 285 | 286 | 3.0 | Very |
| | | | | | | | | | | uniform |
| | | 0.4 | 285 | 272 | 262 | 261 | 260 | 256 | 3.0 | Very |
| | | | | | | | | | | uniform |
| | | 0.5 | 287 | 277 | 273 | 266 | 262 | 260 | 3.0 | Very |
| | | | | | | | | | | uniform |
| | 2 wt % | 0.1 | 347 | 334 | 324 | 316 | 304 | 297 | 3.0 | Very |
| | Aqueous | | | | | | | | | uniform |
| | solution | 0.2 | 312 | 305 | 288 | 281 | 269 | 267 | 3.0 | Very |
| | | | | | | | | | | uniform |
| | | 0.3 | 298 | 286 | 281 | 275 | 272 | 271 | 3.0 | Very |
| | | | | | | | | | | uniform |
| | | 0.4 | 284 | 275 | 271 | 266 | 263 | 262 | 3.0 | Very |
| | | | | | | | | | | uniform |
| | | 0.5 | 270 | 264 | 260 | 258 | 253 | 253 | 3.0 | Very |
| | | | | | | | | | | uniform |

Referring to Table 4, when the cellulose ether-based compound (HPMC) was prepared in the form of a powder or a 2 wt % aqueous solution, added to recombined whole milk or recombined low-fat milk, heated and stirred to form froth, a sufficient amount of forth was formed at every concentration of HPMC, and thus cream flavor intensities increased. In this regard, it was confirmed that a froth beverage with improved mouth-feel may be prepared with a small amount of milk even when recombined milk, in which protein is severely denatured by heat-treatment, is used.

### Comparative Examples 1 and 2 and Examples 1 to 6

Coffee beverage compositions of Comparative Examples 1 and 2 and Examples 1 to 6 were prepared by using ingredients and mixing ratios in Table 5. In particular, a coffee solution was prepared by dissolving a coffee powder in hot water (100□), other ingredients were added to a milk foamer (LM-300P, available from Top Electric Appliance Industry) to form a mixture, and the mixture was heated (from 25° C. to 75° C.) and stirred (at 2,5000 rpm) to prepare a froth milk with a sufficient amount of froth, and the two solutions were mixed at a weight ratio of 50:50. The milk foamer was equipped with a heat source and a stirring device, and thus when a hot type was selected, cold milk or milk at room temperature was vigorously stirred while heating the milk, and the stirring stopped when a temperature of the milk reached a certain temperature (75° C.). The whole milk, low-fat milk, whole milk powder, skimmed milk powder, and HPMC were the same as those used in Experimental Examples 1 to 3. The coffee powder was Maxim Original available from Dongsuh Food. Also, qualities of the coffee beverage compositions were evaluated in the manner described below, and the results are shown in Table 5.

TABLE 5

| | | Mixing ratio (wt %) | | | | | | | |
|---|---|---|---|---|---|---|---|---|---|
| | | Comparative | | | | | | | |
| | | Example | | Example | | | | | |
| | Ingredient | 1 | 2 | 1 | 2 | 3 | 4 | 5 | 6 |
| Coffee | Coffee powder | 0.7 | 0.7 | 0.7 | 0.7 | 0.7 | 0.7 | 0.7 | 0.7 |
| solution | Purified water | 49.3 | 49.3 | 49.3 | 49.3 | 49.3 | 49.3 | 49.3 | 49.3 |
| Froth | Whole milk | 50 | 25 | 25 | 25 | 0 | 0 | 0 | 0 |
| milk | Low-fat milk | 0 | 0 | 0 | 0 | 0 | 25 | 25 | 0 |
| | Whole milk | 0 | 0 | 0 | 0 | 3 | 0 | 0 | 0 |
| | powder | | | | | | | | |
| | Skimmed milk | 0 | 0 | 0 | 0 | 0 | 0 | 0 | 3 |
| | powder | | | | | | | | |
| | Whey powder | 0 | 1.25 | 1.25 | 1.25 | 1.25 | 1.5 | 1.5 | 1.5 |
| | Maltodextrin | 0 | 1.5 | 1.5 | 1.5 | 1.5 | 1.5 | 1.5 | 1.5 |
| | Flavor A | 0 | 0.03 | 0.03 | 0.03 | 0 | 0.05 | 0.05 | 0 |
| | Flavor B | 0 | 0 | 0 | 0 | 0.075 | 0 | 0 | 0.09 |
| | HPMC powder | 0 | 0 | 0.15 | 0 | 0.1 | 0.15 | 0 | 0.15 |
| | 2 wt % HPMC | 0 | 0 | 0 | 5 | 0 | 0 | 5 | 0 |
| | aqueous solution | | | | | | | | |
| | Purified water | 0 | 22.07 | 22.07 | 17.22 | 44.075 | 21.8 | 16.95 | 43.76 |
| Total | | 100 | 100 | 100 | 100 | 100 | 100 | 100 | 100 |
| Froth | | A | C | A | A | A | A | A | A |
| Smoothness of cream | | 5 | 3 | 5 | 5 | 5 | 5 | 5 | 5 |
| Cream flavor intensity | | 5 | 3 | 5 | 5 | 5 | 5 | 5 | 5 |
| Nutrient | Calories | 35 | 29 | 29 | 29 | 28 | 24 | 24 | 24 |
| components | (cal/100 ml) | | | | | | | | |
| | Fat (g) | 1.5 | 1 | 1 | 1 | 0.8 | 0.3 | 0.3 | 0 |
| | Saturated fat (g) | 1.3 | 0.6 | 0.6 | 0.6 | 0.6 | 0.13 | 0.13 | 0 |
| | Cholesterol (mg) | 7.5 | 3.8 | 3.8 | 3.8 | 3.5 | 0.7 | 0.7 | 0 |

* Flavor A is a cream flavor available from Samjeong Flavors (1202481, liquid), and Flavor B is a milk flavor available from Jibodan Korea (P-081266, powder).

<Evaluation Criteria>

(1) Froth

In Comparative Example 1, when froth formed by milk only was 100%, “A” referred to a case when froth was formed and remained at a level of 80% or higher, “B” referred to a case when froth was formed and remained at a level of 50% or higher, and “C” referred to a case when froth was formed and remained at a level of lower than 50%.

(2) Smoothness of cream and cream flavor intensity

Smoothness of cream and cream flavor intensities were evaluated in a 5-point scale. A point of a greater number indicates more smoothness of cream and greater cream flavor intensity.

(3) Calories and contents of fat, saturated fat, and cholesterol

Calories and contents of fat, saturated fat, and cholesterol were calculated by using data shown in Table 6. Table 6 shows calories of each nutrient component per 100 g of whole milk, low-fat milk, whole milk powder, or skimmed milk powder. The data of Table 6 was prepared based on the analysis results posted on a product of each component and food nutrient component database provided by Atwater index and KFDA. According to Atwater index, calories per 1 g of carbohydrate is 4 kcal, calories per 1 g of fat is 9 kcal, and calories per 1 g of protein is 4 kcal.

TABLE 6

| | | Carbo- | | | Saturated | Cho- |
|---|---|---|---|---|---|---|
| | Calories | hydrate | Protein | Fat | fat | lesterol |
| | (kcal) | (g) | (g) | (g) | (g) | (mg) |
| Coffee powder | 352 | 68.6 | 19.5 | 0 | 0 | 0 |
| Whole milk | 65 | 4.5 | 3 | 4 | 2.5 | 15 |
| Low-fat milk | 40 | 5 | 3 | 1 | 0.5 | 2.5 |
| Whole milk | 495 | 38 | 26 | 27 | 19 | 114 |
| powder | | | | | | |
| Skimmed milk | 355 | 52 | 35 | 1 | 0.5 | 22 |
| powder | | | | | | |
| Whey powder | 339 | 73.45 | 11.73 | 0.54 | 0.34 | 3 |
| Maltodextrin | 380 | 95 | 0 | 0 | 0 | 0 |

Referring to Table 5, the coffee beverage compositions prepared in Examples 1 to 6 in which a content of a milk element is relatively small had similar quality with the coffee beverage composition prepared in Comparative Example 1 having a high content of a milk element, and the coffee beverage compositions prepared in Examples 1 to 6 had about 17% reduced calories, about 33% reduced fat content, about 53% reduced saturated fat content, and about 51% reduced cholesterol content.

Also, referring to Table 5, even though the coffee beverage compositions prepared in Examples 1 to 6 have a content of a milk element that is similar to that of the coffee beverage composition prepared in Comparative Example 2, the coffee beverage compositions prepared in Examples 1 to 6 had more amount of froth, less calories, a reduced content of fat, a reduced content of saturated fat, and a reduced content of cholesterol compared to those of the coffee beverage composition prepared in Comparative Example 2.

### Comparative Example 3 and Examples 7 to 14

Cocoa beverage compositions of Comparative Example 3 and Examples 7 to 14 were prepared by using ingredients and mixing ratios shown in Table 7. In particular, each of the cocoa beverage compositions was prepared by adding the ingredients other than milk to a mixture solution of milk and purified water. Then, the cocoa beverage composition was placed in a milk foamer (LM-300P, available from Top Electric Appliance Industry), heated (from 25° C. to 75° C.) and stirred (at 2,5000 rpm) to form a sufficient amount of froth, and transferred to a beaker having a diameter of 75 mm. The whole milk, low-fat milk, whole milk powder, skimmed milk powder, and HPMC were the same as those used in Experimental Examples 1 to 3. The cocoa powder was a 100% cocoa powder product available from ADM, and the chicory dietary fiber was available from Orafti. Also, qualities of the froth beverage compositions were evaluated, and the results are shown in Table 7.

TABLE 7

| | Mixing ratio (wt %) | | | | | | | | |
|---|---|---|---|---|---|---|---|---|---|
| | Comparative | Example | | | | | | | |
| | Example 3 | 7 | 8 | 9 | 10 | 11 | 12 | 13 | 14 |
| Cocoa powder | 2.00 | 2.00 | 2.00 | 2.00 | 2.00 | 2.00 | 2.00 | 2.00 | 2.00 |
| Sugar | 8.00 | 8.00 | 8.00 | 8.00 | 8.00 | 8.00 | 8.00 | 8.00 | 8.00 |
| Maltodextrin | 1.00 | 1.00 | 1.00 | 1.50 | 1.00 | 1.50 | 1.00 | 1.00 | 1.50 |
| Polydextrose | 0.00 | 0.00 | 0.00 | 0.00 | 0.00 | 1.00 | 0.00 | 0.00 | 1.00 |
| Whey protein | 0.00 | 0.00 | 0.00 | 0.00 | 0.00 | 0.50 | 0.00 | 0.00 | 0.50 |
| (WPC) | | | | | | | | | |
| Chicory | 0.00 | 0.00 | 0.00 | 0.00 | 0.00 | 1.00 | 0.00 | 0.00 | 1.00 |
| dietary fiber | | | | | | | | | |
| Whey powder | 1.00 | 1.00 | 1.00 | 1.00 | 1.00 | 1.00 | 2.50 | 2.50 | 2.50 |
| Whole milk | 1.00 | 1.00 | 1.00 | 4.00 | 4.00 | 3.00 | 1.00 | 1.00 | 1.00 |
| powder | | | | | | | | | |
| Skimmed | 3.50 | 3.50 | 3.50 | 3.50 | 3.50 | 3.50 | 5.00 | 5.00 | 5.00 |
| milk powder | | | | | | | | | |
| HPMC | 0.00 | 0.30 | 0.00 | 0.30 | 0.00 | 0.30 | 0.40 | 0.00 | 0.35 |
| powder | | | | | | | | | |
| 2 wt % | 0.00 | 0.00 | 15.00 | 0.00 | 15.00 | 0.00 | 0.00 | 20.00 | 0.00 |
| HPMC | | | | | | | | | |
| aqueous | | | | | | | | | |
| solution | | | | | | | | | |
| Whole milk | 50.00 | 30.00 | 30.00 | 0.00 | 0.00 | 0.00 | 0.00 | 0.00 | 0.00 |
| Cappuccino | 0.00 | 0.00 | 0.00 | 0.05 | 0.05 | 0.06 | 0.05 | 0.05 | 0.05 |
| flavor | | | | | | | | | |
| Milk flavor | 0.00 | 0.00 | 0.00 | 0.05 | 0.05 | 0.06 | 0.08 | 0.08 | 0.08 |
| Purified water | 33.50 | 53.20 | 38.50 | 79.60 | 65.40 | 78.08 | 79.97 | 60.37 | 77.02 |
| Total | 100.00 | 100.00 | 100.00 | 100.00 | 100.00 | 100.00 | 100.00 | 100.00 | 100.00 |
| Calories | 92 | 79 | 79 | 76 | 76 | 81 | 70 | 70 | 81 |
| (cal/100 ml) | | | | | | | | | |
| Fat (g) | 2.6 | 1.8 | 1.8 | 1.4 | 1.4 | 1.1 | 0.6 | 0.6 | 0.6 |
| Saturated fat | 1.6 | 1.1 | 1.1 | 1.0 | 1.0 | 0.8 | 0.4 | 0.4 | 0.4 |
| (g) | | | | | | | | | |
| Cholesterol | 9.4 | 6.4 | 6.4 | 5.3 | 5.3 | 4.2 | 2.3 | 2.3 | 2.3 |
| (mg) | | | | | | | | | |

*A cappuccino flavor was available from Samjeong Flavors (1202482, powder), and a milk flavor was available from Jibodan Korea (P-081266, powder).

In Table 7, calories, and contents of fat, saturated fat, and cholesterol of the cocoa beverage composition were calculated by using data shown in Table 8. Table 8 shows calories of each nutrient component per 100 g of whole milk, low-fat milk, whole milk powder, or skimmed milk powder. The data of Table 8 was prepared based on the analysis results posted on a product of each component and food nutrient component database provided by Atwater index and KFDA. According to Atwater index, calories per 1 g of carbohydrate is 4 kcal, calories per 1 g of fat is 9 kcal, and calories per 1 g of protein is 4 kcal.

TABLE 8

| | | Carbo- | | | Saturated | Cho- |
|---|---|---|---|---|---|---|
| | Calories | hydrate | Protein | Fat | fat | lesterol |
| | (kcal) | (g) | (g) | (g) | (g) | (mg) |
| Cocoa powder | 229 | 54.8 | 19.6 | 13.7 | 8.7 | 0.0 |
| Sugar | 380 | 95.0 | 0 | 0 | 0 | 0 |
| Maltodextrin | 380 | 95.0 | 0 | 0 | 0 | 0 |
| Polydextrose | 380 | 95.0 | 0 | 0 | 0 | 0 |
| Whey protein | 380 | 0.0 | 85 | 0 | 0 | 0 |
| (WPC) | | | | | | |
| Chicory dietary | 380 | 95.0 | 0 | 0 | 0 | 0 |
| fiber | | | | | | |
| Whey powder | 339 | 73.5 | 12 | 0.5 | 0.3 | 3.0 |
| Whole milk | 495 | 38.0 | 26 | 27 | 19 | 114.2 |
| powder | | | | | | |
| Skimmed milk | 355 | 52.0 | 35 | 1 | 0.5 | 22.2 |
| powder | | | | | | |
| Whole milk | 65 | 4.5 | 3 | 4 | 2.5 | 15.0 |

Referring to Table 8, the cocoa beverage compositions prepared in Examples 7 to 14 had about 12% or more reduced calories, about 31% or more reduced fat content, about 31% or more reduced saturated fat content, and about 32% or more reduced cholesterol content compared to those of the cocoa beverage composition prepared on Comparative Example 3.

Qualities and flavors of froth formed in Comparative Example 3 and Examples 7 to 14 were evaluated, and the results are shown in Table 9.

TABLE 9

| | Height of froth according to | | | | | | | | | | | |
|---|---|---|---|---|---|---|---|---|---|---|---|---|
| | elapsed time (mm) | | | | | Cocoa | Cream flavor | Amount | Uniformity | Firmness | Froth | Size of |
| | 1 min | 3 min | 6 min | 9 min | 12 min | intensity | intensity | of froth | of froth | of froth | durability | froth |
| Comp. | 58.4 | 52.5 | 49.1 | 49.2 | 48.0 | 3.0 | 4.5 | Appropriate | Uniform | Weak | Good | Small |
| Exam. 3 | | | | | | | | | | | | |
| Exam. 7 | 90.0 | 77.2 | 68.6 | 60.4 | 53.3 | 2.5 | 4.5 | Abundant | Uniform | Appropriate | Good | Small |
| Exam. 8 | 90.3 | 76.8 | 70.7 | 62.1 | 54.2 | 2.5 | 4.5 | Abundant | Uniform | Appropriate | Good | Small |
| Exam. 9 | 88.1 | 74.3 | 67.0 | 60.0 | 54.0 | 2.5 | 4.5 | Abundant | Uniform | Appropriate | Good | Small |
| Exam. | 79.7 | 70.0 | 65.0 | 59.0 | 53.0 | 2.5 | 4.5 | Abundant | Uniform | Appropriate | Good | Small |
| 10 | | | | | | | | | | | | |
| Exam. | 83.0 | 67.1 | 58.0 | 45.0 | 33.0 | 2.5 | 4.5 | Abundant | Uniform | Appropriate | Good | Small |
| 11 | | | | | | | | | | | | |
| Exam. | 92.1 | 83.1 | 75.4 | 71.3 | 68.9 | 2.5 | 4.0 | Abundant | Uniform | Appropriate | Good | Small |
| 12 | | | | | | | | | | | | |
| Exam. | 88.0 | 82.3 | 76.5 | 72.0 | 67.3 | 2.5 | 4.0 | Abundant | Uniform | Appropriate | Good | Small |
| 13 | | | | | | | | | | | | |
| Exam. | 89.0 | 81.9 | 75.2 | 70.1 | 66.4 | 2.5 | 4.0 | Abundant | Uniform | Appropriate | Good | Small |
| 14 | | | | | | | | | | | | |

<Evaluation Criteria>

(1) Height (mm) of froth according to elapsed time

A height of froth according to elapsed time was measured after heating (from 25° C. to 75° C.), stirring (at 2,500 rpm), and transferring to a container having a diameter of 75 mm.

(2) Cocoa intensity and cream flavor intensity

Cocoa intensity and cream flavor intensity were evaluated in a 5-point scale. A point of a greater number indicates higher intensity.

(3) Uniformity and size of froth

Uniformity and size of froth were evaluated with naked eyes.

(4) Froth durability

When an initial froth production amount was 100%, “good” indicated that 50% or more of an amount of the froth remained after 12 minutes, and “not good” indicated otherwise.

(5) Amount of froth

The term “insufficient” denotes a case when the height of the froth measured in (1) was less than 40 mm, “appropriate” when the height was 40 mm or higher and less than 80 mm, and “abundant” when the height was 80 mm or higher.

(6) Firmness of froth

Firmness of froth was classified into “weak”, “appropriate”, or “strong” through a sensory evaluation.

Referring to Table 9, flavors and froth qualities of the cocoa beverage compositions prepared in Examples 7 to 14 were similar with or better than those of the cocoa beverage composition prepared in Comparative Example 3.

While the inventive concept has been particularly shown and described with reference to exemplary embodiments thereof, it will be understood that various changes in form and details may be made therein without departing from the spirit and scope of the following claims.

1. A froth beverage composition comprising:
a flavoring agent comprising at least one of a milk element and an excipient; and
a cellulose ether-based compound,
wherein a solid content of the cellulose ether-based compound is in a range of about 1 part to about 5 parts by weight based on 100 parts by weight of a solid content of the flavoring agent.

2. The froth beverage composition of claim 1 further comprising:
a vegetable main ingredient; and
a congener,
wherein solid contents of the flavoring agent and the congener are in a range of about 100 parts to about 900 parts and a range of about 0.2 parts to about 13 parts by weight, respectively, based on 100 parts by weight of the vegetable main ingredient.

3. The froth beverage composition of claim 2 further comprising water, wherein a content of the water in the froth beverage composition is in a range of about 700 parts to about 14,000 parts by weight based on 100 parts by weight of the vegetable main ingredient.

4. The froth beverage composition of claim 2, wherein the vegetable main ingredient comprises at least one selected from the group consisting of coffee, cocoa, green tea, sweet potato, red tea, blueberry, and sweet pumpkin.

5. The froth beverage composition of claim 2, wherein the congener comprises at least one selected from the group consisting of coffee flavor, milk flavor, cream flavor, vanilla flavor, butter flavor, coconut flavor, chocolate flavor, oleaginous seed flavor, green tea flavor, sweet potato flavor, red tea flavor, blueberry flavor, and sweet pumpkin flavor.

6. The froth beverage composition of claim 1, wherein the milk element comprises at least one selected from the group consisting of raw milk, whole milk, low-fat milk, non-fat milk, functional milk, recombined milk, whole milk powder, skimmed milk powder, and whey powder.

7. The froth beverage composition of claim 1, wherein the excipient comprises at least one selected from the group consisting of maltodextrin, polydextrose, inulin, indigestible carbohydrates, whey protein, whey powder, casein, sodium caseinate, milk protein, whey protein isolate, water-soluble dietary fiber, and insoluble dietary fiber.

8. The froth beverage composition of claim 1, wherein the cellulose ether-based compound comprises at least one selected from the group consisting of hydroxypropylmethyl cellulose, methyl cellulose, and hydroxypropyl cellulose.

9. A process for preparing a froth beverage, the process comprising heating and stirring a mixture comprising at least one of a milk element and an excipient, a cellulose ether-based compound, and water to form froth.

10. The process of claim 9, wherein the heating of the mixture is performed at a temperature in a range of about 25° C. to about 75° C.

11. The process of claim 9, wherein the mixture further comprises at least one of a vegetable main ingredient and a congener.
